(19) United States
(12) Patent Application Publication
(10) Pub. No.: US 2025/0334506 A1
(43) Pub. Date: Oct. 30, 2025

(54) FLOW CELL DESIGNS AND INTEGRATED SYSTEMS FOR ENHANCED RAMAN SPECTROSCOPY ANALYSIS

(71) Applicant: FIAlab Instruments, Inc., Seattle, WA (US)

(72) Inventors: Ilkka Lahdesmaki, Seattle, WA (US); Daniel Hasle, Seattle, WA (US)

(21) Appl. No.: 19/256,190

(22) Filed: Jul. 1, 2025

Related U.S. Application Data
(63) Continuation-in-part of application No. 18/238,460, filed on Aug. 26, 2023.

(51) Int. Cl. G01N 21/01; G01N 21/65

(52) U.S. Cl. CPC G01N 21/01; G01N 21/65

(57) ABSTRACT

The present invention relates to improved Raman spectroscopy flow cells and integrated systems for in situ analysis of fluid samples under enclosed conditions. Two novel flow cell designs are disclosed: a Z-design, featuring an angled optical path with a beam dump cavity lined with non-reflective, non-fluorescent material to reduce optical noise, and a T-design, featuring a horizontal flow channel with vertical optical access through a window, sealed using standard O-rings. Both designs isolate the Raman probe from direct fluid contact, minimize dead volume, and facilitate efficient beam management for enhanced signal-to-noise ratio. The invention also covers integrated systems comprising a Raman spectrometer, probe, and the improved flow cells, enabling real-time, high-accuracy fluid analysis in industrial and laboratory environments. These designs improve optical performance, manufacturability, and adaptability across a range of Raman spectroscopy applications.

### CROSS-REFERENCE TO RELATED PATENT DOCUMENTS

This Application is a Continuation-in-part of U.S. patent application Ser. No. 18/238,460, titled “ANTI-REFLECTIVE, NONFLUORESCENT MEASUREMENT ARRANGEMENT FOR ENHANCED SAMPLE ANALYSIS,” filed on Aug. 26, 2023, which is incorporated herein by reference in its entirety.

### FIELD OF THE INVENTION

The present invention pertains to the field of analytical techniques and materials used in sample analysis. Specifically, the invention relates to the introduction of an innovative anti-reflective, nonfluorescent measurement arrangement designed to improve the accuracy, sensitivity, and overall performance of sample analysis methods, such as Raman spectroscopy and other similar analytical approaches.

### BACKGROUND

The analysis of samples using techniques such as Raman spectroscopy plays a crucial role in numerous scientific and industrial fields. However, the accuracy and sensitivity of such analyses can be hindered by several challenges, including unwanted reflections and fluorescence from the sample itself or surrounding materials. This background section aims to highlight these existing problems and emphasize the need for an innovative solution-the introduction of an anti-reflective, nonfluorescent measurement arrangement.

One of the primary challenges in sample analysis is the presence of unwanted reflections from the sample's surface or interfaces. When a laser beam is incident on a sample, a portion of the incident light reflects off the sample's surface, causing interference with the desired Raman scattered light. These reflections can lead to distorted spectra, reduced signal-to-noise ratio, and inaccurate analysis. Additionally, highly reflective surfaces can also cause laser-induced damage to sensitive samples, limiting their applicability. Fluorescence is another significant issue encountered during sample analysis. Many organic and inorganic compounds possess fluorescent properties, wherein they absorb incident light and subsequently emit light at longer wavelengths. The emission of fluorescence can significantly overlap with the Raman scattered light, making it difficult to discern the Raman signal from the background fluorescence. This interference can mask or distort Raman spectral peaks, compromising the accuracy of molecular identification and analysis. Both unwanted reflections and fluorescence can substantially reduce the sensitivity and detection limit of Raman spectroscopy. Uncontrolled reflections can overwhelm weak Raman signals, making it challenging to detect and analyze low-concentration analytes. Similarly, fluorescence interference can obscure or distort Raman signals, limiting the ability to detect and identify trace amounts of compounds. Consequently, these challenges impede the comprehensive characterization of samples, hinder the identification of subtle molecular differences, and limit the technique's broader applicability.

To address these challenges and enhance the capabilities of sample analysis techniques, there is a pressing need for an innovative solution: the development and utilization of an anti-reflective, nonfluorescent material in the measurement setup. This material would possess unique properties that reduce unwanted reflections and minimize or eliminate fluorescence interference, thereby enhancing the accuracy, sensitivity, and detection limit of Raman spectroscopy and similar analytical methods. By introducing an anti-reflective, nonfluorescent measurement arrangement into the sample analysis process, it becomes possible to improve the overall quality of Raman spectra and enable more precise identification and characterization of samples. This innovative solution has the potential to revolutionize a wide range of applications, including pharmaceuticals, materials science, environmental analysis, and life sciences, ultimately driving advancements and discoveries in these fields.

### BRIEF SUMMARY

The present invention discloses an innovative anti-reflective, nonfluorescent measurement arrangement designed to improve the accuracy, sensitivity, and overall performance of sample analysis methods, such as Raman spectroscopy and other similar analytical approaches. The anti-reflective, nonfluorescent material addresses longstanding challenges in sample analysis, primarily concerning unwanted reflections and fluorescence interference. By integrating this novel material into the sample analysis process, it mitigates the adverse effects of reflections from sample surfaces and interfaces, reducing interference with the desired Raman scattered light. Additionally, the material minimizes or eliminates fluorescence, preventing overlap with the Raman signals and enhancing the clarity of spectra. This groundbreaking invention opens new horizons in the field of analytical chemistry, materials science, and other related disciplines. It significantly enhances the capabilities of sample analysis techniques, allowing for more accurate identification and comprehensive characterization of samples, even at trace concentrations. The anti-reflective, nonfluorescent measurement arrangement holds great promise to revolutionize various applications, including pharmaceuticals, materials characterization, environmental monitoring, and life sciences, facilitating advancements in research, development, and industrial processes. The novel arrangement's unique properties and wide-ranging applications make it an essential asset in improving the accuracy and sensitivity of analytical methods, thereby advancing scientific understanding and innovation across diverse domains. The introduction of this anti-reflective, nonfluorescent arrangement represents a substantial leap forward in sample analysis technology, bringing forth numerous benefits and transformative impacts in the broader scientific and industrial communities.

In one embodiment, the fountain type design of the Raman spectroscopy system represents a novel approach to accurate and efficient sample analysis. Comprising two essential compartments—an upper and a bottom compartment—this design integrates critical components to enable precise fluid handling and interaction with the optical probe. In the upper compartment, key elements include an optical probe, securing nut, O-ring, fluid inlet, and fluid outlet. The optical probe, directed by the securing nut, guides a laser beam onto the sample, while the O-ring maintains a sealed connection between compartments. The fluid inlet and outlet facilitate controlled sample introduction and removal, ensuring seamless fluid flow for accurate analysis. Moving to the bottom compartment, the fluid inlet channel acts as the optical interface, allowing laser beam penetration and sample interaction. The groundbreaking innovation here is aligning the fluid inlet channel with the laser beam. This design effectively mitigates undesired optical effects, such as reflections and fluorescence interference, significantly enhancing measurement accuracy. A sealing gasket further ensures the separation of compartments and system integrity while providing a route for the sample solution to flow through the measurement cell. The fountain type design of the Raman spectroscopy system provides a comprehensive solution for accurate analysis. By strategically incorporating components in both compartments, this design optimizes accuracy and reliability while maintaining the integrity of the sample.

In another embodiment, the sheet flow design of the Raman spectroscopy system introduces a sophisticated approach to precise sample analysis. Built upon two key compartments—upper and bottom—this design seamlessly integrates components for fluid management and optical interaction. Within the upper compartment, critical components include an optical probe, securing nut, O-ring, fluid inlet, and fluid outlet. The optical probe, secured by the nut, expertly directs a laser beam onto the sample, while the O-ring ensures a tight seal, preventing leakage. The fluid inlet and outlet offer controlled sample routing, promoting smooth fluid flow for accurate analysis. Transitioning to the bottom compartment, the window functions as the optical interface, permitting laser beam interaction with the sample. Notably, the anti-reflective, non-fluorescent material plays a pivotal role in this design, minimizing optical interference and enhancing measurement accuracy. A gasket maintains compartmental separation, guaranteeing system integrity while providing a route for the sample solution to flow through the measurement cell. Of particular significance is the top view of the bottom compartment, emphasizing the diamond-shaped cutout's role in fluid flow. The fluid's-controlled movement through this cutout ensures uniform interaction with the laser beam for accurate measurements.

The present invention introduces a novel approach to Raman spectroscopy by enabling measurements on fluid samples within enclosed environments such as process reactors, process streams, and fluidic instruments. By utilizing a specially designed flow cell, the invention allows for Raman spectroscopic measurements without compromising the integrity of the fluid being analyzed. The key feature of the invention is the incorporation of an optical interface that faces either the fluid under investigation or a transparent window. The material opposite the optical interface is either not present at all, or is constructed using anti-reflective and nonfluorescent properties, thereby preventing any reflections or fluorescence interference from occurring within the flow cell. This ensures accurate and reliable Raman spectroscopy measurements. Furthermore, the invention facilitates the use of a flat-bottom probe as the optical interface, which is a commonly utilized probe design in Raman spectrometry. This allows for seamless integration of the invention with existing Raman spectroscopy setups and equipment. The application of this invention has significant advantages in various fields, particularly in processes involving fluids where enclosed conditions are necessary to maintain the integrity of the sample. By enabling Raman spectroscopic measurements in situ, the invention provides valuable insights into chemical composition and molecular structure without exposing the fluid to ambient conditions or compromising the overall process integrity. Overall, this innovative approach to Raman spectroscopy within enclosed environments, utilizing an anti-reflective, nonfluorescent material and a flat-bottom probe as the optical interface, offers improved accuracy, sensitivity, and convenience in sample analysis, opening new possibilities for scientific research, industrial processes, and real-time monitoring of fluidic systems.

The present invention further discloses an improved Raman spectroscopy flow cell designs for analyzing fluid samples under enclosed or controlled conditions. In particular, the invention introduces two novel flow cell architectures, referred to as the Z-design and the T-design, which address limitations in prior designs such as optical interference, probe contamination, and manufacturing complexity, while preserving the core functional advantages of in situ Raman analysis.

The Z-design flow cell comprises an angled optical channel through which a laser beam from a Raman probe passes before interacting with a fluid sample. The beam path is configured to allow the excitation beam to propagate through the fluid volume before encountering any hard surface, reducing background noise caused by beam reflections or scattering. A transparent window is provided between the Raman probe and the fluid sample, preventing direct contact and thereby minimizing contamination, wear, and cleaning requirements. A key feature of the Z-design is the inclusion of a beam dump cavity aligned with the optical axis. This cavity is optionally lined with non-reflective and non-fluorescent material to absorb unscattered portions of the laser beam, improving the signal-to-noise ratio and reducing spurious background signals.

The T-design flow cell offers a compact, modular alternative suitable for high-precision applications with minimal dead volume. It includes a horizontal fluidic channel with inlet and outlet ports, and a perpendicularly oriented optical port for laser excitation and Raman signal collection. A transparent window is positioned between the optical port and the sample channel, isolating the Raman probe from direct contact with the fluid. The design enables the use of standard O-rings for sealing, replacing the need for custom gaskets and improving manufacturing scalability and pressure resistance. The fluid ports are located outside the probe holder, simplifying customization of the flow cell for different Raman probe sizes. A beam dump cavity is positioned below the optical axis to absorb any residual excitation light and suppress background interference.

Both the Z-design and T-design flow cells are configured to be easily integrated with standard Raman probes and optical components, enabling enhanced measurement reliability, ease of maintenance, and adaptability to various industrial and research environments. These improvements significantly expand the practical utility of Raman spectroscopy for fluid analysis while ensuring high optical fidelity and operational robustness.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIGS. 1 and 2 are diagrams that illustrate a side view of a Raman Spectroscopy system and present a fountain type design of the Raman Spectroscopy system, in accordance with an embodiment of the present invention.

FIG. 3 is a diagram that illustrates a top view and a side view of a bottom compartment of the fountain type Raman Spectroscopy system, in accordance with an embodiment of the present invention.

FIGS. 4 and 5 are diagrams that illustrate a side view of a Raman Spectroscopy system and present a sheet flow design of the Raman Spectroscopy system, in accordance with another embodiment of the present invention.

FIG. 6 is a diagram that illustrates a top view of a bottom compartment of the sheet flow Raman Spectroscopy system, in accordance with another embodiment of the present invention.

FIG. 7 is a diagram that illustrates an arrangement for presenting Raman probe operation, in accordance with an embodiment of the present invention.

FIG. 8 is a diagram that illustrates a Z-style Raman spectroscopy flow cell, in accordance with an embodiment of the present invention.

FIG. 9 is a diagram that illustrates a T-style Raman spectroscopy flow cell, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components or set-ups, which constitutes introduction of an innovative anti-reflective, nonfluorescent measurement arrangement designed to improve the accuracy, sensitivity, and overall performance of sample analysis methods, such as Raman spectroscopy and other similar analytical approaches. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The present invention relates to improved Raman spectroscopy flow cells and integrated systems for in situ analysis of fluid samples under enclosed conditions. The first embodiment relates to a Z-shaped Raman spectroscopy flow cell designed to improve signal quality, reduce optical interference, and enable real-time sample analysis under enclosed or process conditions. The system includes a flow cell having an optical channel configured to receive a laser beam from a Raman probe. The optical channel is specifically angled, creating an oblique path through the flowing fluid sample. This angled path ensures that the laser beam travels a greater distance through the fluid before encountering a solid surface, allowing the beam to expand beyond its focal point. This reduces the intensity of any reflected or scattered light that could otherwise interfere with signal detection, thereby improving signal-to-noise ratio and reducing background fluorescence. To isolate the Raman probe from direct contact with the fluid sample, a transparent window is provided between the optical probe and the optical channel. This window allows the laser beam to pass through and interact with the fluid while maintaining the cleanliness and longevity of the probe. The window is preferably sealed with an O-ring, which provides a leak-proof, removable interface that is both reliable and easy to manufacture using off-the-shelf components. A critical component of the system is a beam dump cavity aligned with the optical axis of the incoming laser beam. After passing through the fluid sample, unscattered portions of the laser beam are directed into the beam dump cavity. The interior surface of the cavity is coated or lined with non-reflective and non-fluorescent material. This prevents stray laser light from being reflected back into the Raman probe or surrounding optical components, which would otherwise degrade the fidelity of the Raman spectrum. Additionally, the beam dump cavity is housed in a detachable end cap, allowing it to be easily removed for maintenance, inspection, or cleaning. The Raman probe is secured using a set screw or threaded connection, providing both mechanical stability and ease of installation or replacement. These features make the system modular and serviceable, which is important for integration into industrial or high-throughput environments.

The second embodiment relates to a T-shaped Raman spectroscopy system featuring a horizontal fluid flow channel with vertical optical access, optimized for minimal dead volume, case of manufacturing, and improved sealing performance. The system includes a horizontal flow channel equipped with a fluid inlet port and a fluid outlet port, both configured to allow a fluid sample to pass through the channel in a linear manner. The inlet and outlet ports are threaded and positioned outside the probe holder block, which enables flexible integration with standard tubing and easy customization to accommodate various probe geometries without altering the main flow cell structure. An optical port is disposed perpendicularly to the flow channel and is aligned with a Raman probe that delivers excitation light and collects Raman-scattered light. To prevent direct contact between the probe and the fluid sample, a transparent window is positioned between the optical port and the fluid channel. This window allows optical transmission while maintaining separation for hygienic operation, probe protection, and optical clarity. The window is sealed using at least one O-ring, which may be a standard off-the-shelf sealing component, simplifying assembly and improving cost-efficiency and pressure resistance compared to custom gaskets. The window is also removable, allowing it to be cleaned or replaced as needed, which is critical for applications involving fouling or biofilm formation. Aligned with the optical axis below the window is a beam dump cavity, which receives any unscattered or transmitted laser light not absorbed in the sample. The beam dump cavity is preferably housed in a blind end cap, forming a self-contained unit beneath the flow cell. This cavity can be lined with light-absorbing material to reduce stray reflections, ensuring higher signal purity and accuracy during Raman analysis. Together, these features allow the T-design system to offer minimal dead volume, cleanable and replaceable optical components, and high modularity, all while supporting reliable Raman signal acquisition. The design is well-suited for process monitoring, diagnostics, and other real-time analytical applications requiring robust scaling, optical fidelity, and mechanical adaptability.

The invention will now be described with reference to the accompanying drawings which should be regarded as merely illustrative without restricting the scope and ambit of the present invention.

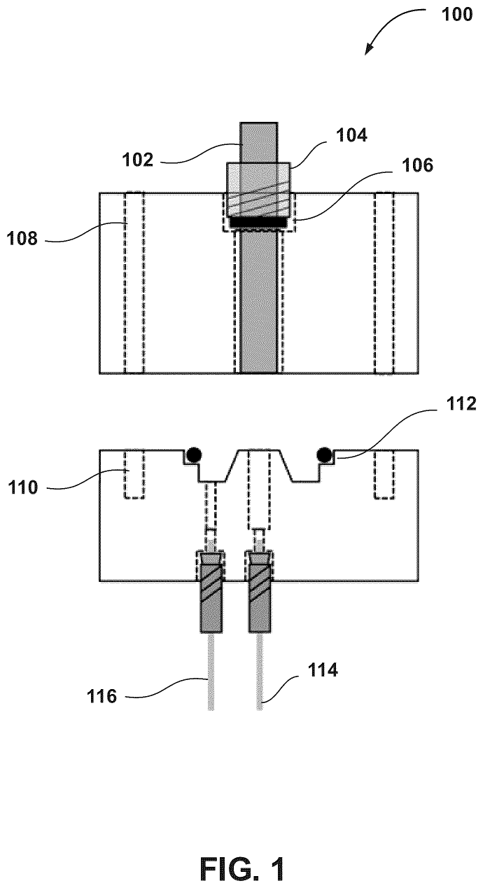

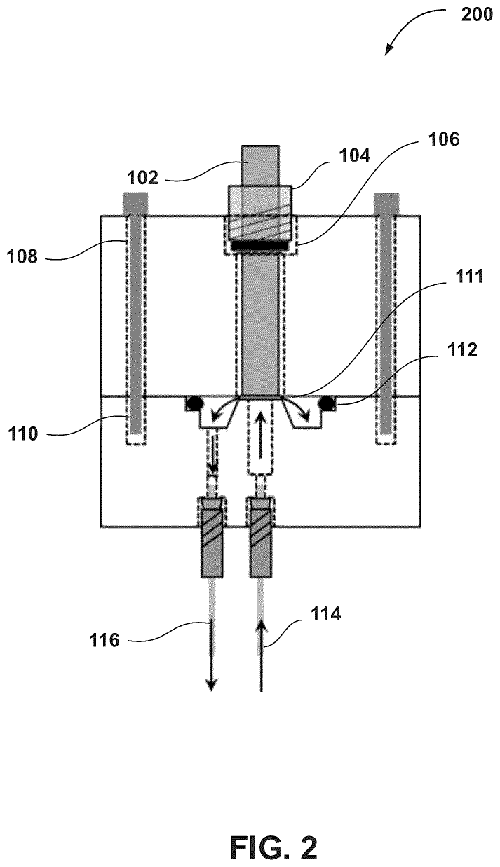

FIGS. 1 and 2 are diagrams 100 and 200 that illustrate a side view of a Raman Spectroscopy system and present a fountain type design of the Raman Spectroscopy system, in accordance with an embodiment of the present invention. As shown, the Raman spectroscopy system comprises two compartments: an upper compartment and a bottom compartment. The upper compartment consists of several components, including an optical probe 102, a securing nut 104, an O-ring 106, and a through hole 108. The optical probe 102 is designed for capturing and directing the laser beam onto the sample. The securing nut 104 is used to hold the optical probe 102 in place securely. The O-ring 106 provides a seal to prevent any leakage or contamination between the compartments. The through hole 108 allows the laser beam to pass through and interact with the sample. The bottom compartment of the Raman spectroscopy system includes a tapped hole, an O-ring 112, a fluid inlet 114, and a fluid drain 116. The tapped hole serves as a connection point for the fluid or sample being analyzed. The O-ring 112 ensures a tight and secure seal between the compartments, preventing any leaks. The fluid inlet 114 is used to introduce the fluid or sample into the system for analysis. The fluid drain 116 allows for the controlled removal of the fluid after analysis. Together, these compartments and their respective components form an integral part of the Raman spectroscopy system. The upper compartment facilitates the laser beam delivery and interaction with the sample, while the bottom compartment enables the controlled introduction and removal of the fluid or sample being analyzed. These design features ensure accurate and efficient sample analysis within the Raman spectroscopy system.

The invention described involves a flow cell designed specifically for Raman spectrometry measurements. This flow cell incorporates the optical probe 102, along with a fluid inlet and outlet 114 and 116, which allow for the controlled routing of the fluid sample into and out of the flow cell during analysis. In one embodiment of the invention, careful consideration is given to the orientation of the fluid inlet 114 in relation to the optical probe 102. The optical probe 102 is positioned in such a way that it faces the inlet channel of the flow cell. This arrangement ensures that the flow cell material itself, which can potentially cause interfering reflections or fluorescence, is not within the field of view of the optical probe 102. By orienting the fluid inlet in this manner, the invention effectively eliminates any undesired optical effects caused by the flow cell material. Reflections that could interfere with the accurate measurement of Raman scattered light are minimized or eliminated entirely. Additionally, fluorescence from the flow cell material, which could obscure or distort the Raman signals, is prevented from entering the optical probe's field of view. This design feature significantly enhances the reliability and accuracy of Raman spectrometry measurements conducted using the flow cell. By ensuring that the optical probe only captures the desired Raman scattered light from the fluid sample, the invention enables precise and unobstructed analysis of the sample's molecular composition and characteristics.

In addition to the previously mentioned features, the Raman spectroscopy system further includes a small gap 111 between the top and bottom compartments, allowing liquid to pass through. This small gap 111 serves as a pathway for the fluid, enabling its flow from the fluid inlet to the fluid outlet within the flow cell. The presence of this gap 111 ensures a continuous and controlled movement of the liquid sample throughout the system. It prevents any unintended pooling or stagnation of the fluid, facilitating its smooth flow and efficient analysis. By incorporating this small gap 111, the system optimizes the fluid dynamics and promotes uniform interaction between the sample and the optical probe. This feature contributes to the accuracy and reliability of the Raman spectroscopy measurements by ensuring consistent and representative analysis of the fluid sample. The gap 111 between the top and bottom compartments serves as an important component of the system, allowing the fluid to freely pass through and enabling seamless analysis of the sample without any obstructions or interruptions.

In summary, the invention's flow cell incorporates the optical probe 102 and fluid inlet/outlet 114/116 for controlled sample routing. By orienting the fluid inlet 114 in a way that optimizes the positioning of the optical probe 102, the invention eliminates any interference caused by the flow cell material, including reflections and fluorescence. This design choice enhances the reliability and accuracy of Raman spectrometry measurements by ensuring unobstructed access to the desired Raman signals from the fluid sample.

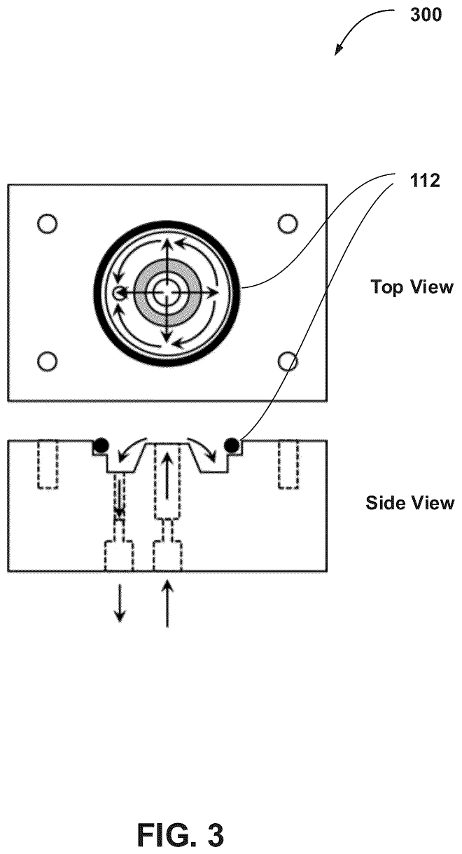

FIG. 3 is a diagram 300 that illustrates a top view and a side view of a bottom compartment of the fountain type Raman Spectroscopy system, in accordance with an embodiment of the present invention. FIG. 3 depicts a top view and side view of the bottom compartment of the fountain type Raman spectroscopy system, illustrating the “fountain-type” operation of the fluid within the flow cell. In the top view, the figure shows the fluid inlet hole, through which the fluid enters the bottom compartment of the flow cell. The optical probe, positioned opposite the inlet hole, is indicated by the presence of the optical probe symbol. The fluid, upon entering through the inlet hole, comes into contact with the bottom of the optical probe. The side view provides a cross-sectional representation of the bottom compartment. It demonstrates the trajectory of the fluid as it interacts with the optical probe. Upon entering the flow cell through the inlet hole, the fluid strikes the bottom surface of the optical probe. This impact causes the fluid to be deflected in a “fountain fashion” or a spray-like manner. As the fluid is deflected, it spreads out and is collected in the trough that surrounds the inlet hole. The trough is designed to efficiently gather the dispersed fluid, preventing it from spreading beyond the designated collection area. This containment ensures that the fluid is kept within the vicinity of the optical probe for accurate analysis. Finally, the fluid exits the bottom compartment through the drain hole, as depicted in the figure. The drain hole serves as the outlet for the fluid, allowing it to be efficiently removed from the flow cell after the analysis is complete.

Overall, FIG. 3 illustrates the specific operational flow pattern within the bottom compartment of the Raman spectroscopy system. The “fountain-type” operation describes the movement of the fluid as it enters through the inlet hole, hits the bottom of the optical probe, is deflected in a spray-like manner, collected in the surrounding trough, and ultimately exits through the drain hole. This design ensures effective fluid handling and optimal interaction with the optical probe for accurate Raman spectroscopy measurements.

As discussed above, the fountain-type design of the Raman spectroscopy system, as depicted in FIGS. 1 to 3, presents an innovative approach for accurate and efficient sample analysis. This system comprises two compartments: an upper compartment and a bottom compartment, each with specific components contributing to seamless fluid handling and interaction with the optical probe. The upper compartment encompasses vital elements, including an optical probe designed to capture and direct the laser beam onto the sample, a securing nut for firm fixation of the optical probe, an O-ring to prevent leakage or contamination, and a through hole for the laser beam to interact with the sample. The bottom compartment contains a tapped hole for fluid connection, an O-ring for a secure seal, a fluid inlet to introduce the sample, and a fluid drain for controlled sample removal. A key innovation lies in the careful orientation of the fluid inlet in relation to the optical probe. By positioning the fluid inlet to face the optical probe, the undesired effects of flow cell material, such as reflections and fluorescence, are mitigated. This arrangement ensures that the optical probe exclusively captures the desired Raman scattered light from the fluid sample, enhancing the accuracy and reliability of measurements. Moreover, a small gap between the top and bottom compartments permits controlled liquid flow. This gap ensures consistent movement of the fluid, preventing pooling and enabling smooth and effective analysis. The gap optimizes fluid dynamics and guarantees uniform interaction between the sample and the optical probe, bolstering measurement accuracy. FIG. 3 vividly illustrates the “fountain-type” operation within the bottom compartment. The fluid enters through the inlet hole, strikes the optical probe, and is deflected in a fountain-like spray. Collected in the surrounding trough, the fluid is efficiently directed to prevent unnecessary dispersion. Finally, the fluid exits through the drain hole, completing the controlled analysis cycle. The fountain-type design of the Raman spectroscopy system, highlighted through FIGS. 1 to 3, showcases a sophisticated approach to fluid handling and sample interaction. The precision-oriented fluid inlet orientation, coupled with the thoughtful gap design, ensures optimal accuracy, reliability, and efficiency in Raman spectrometry measurements. The system's innovative features collectively contribute to enhanced sample analysis within an enclosed and controlled environment.

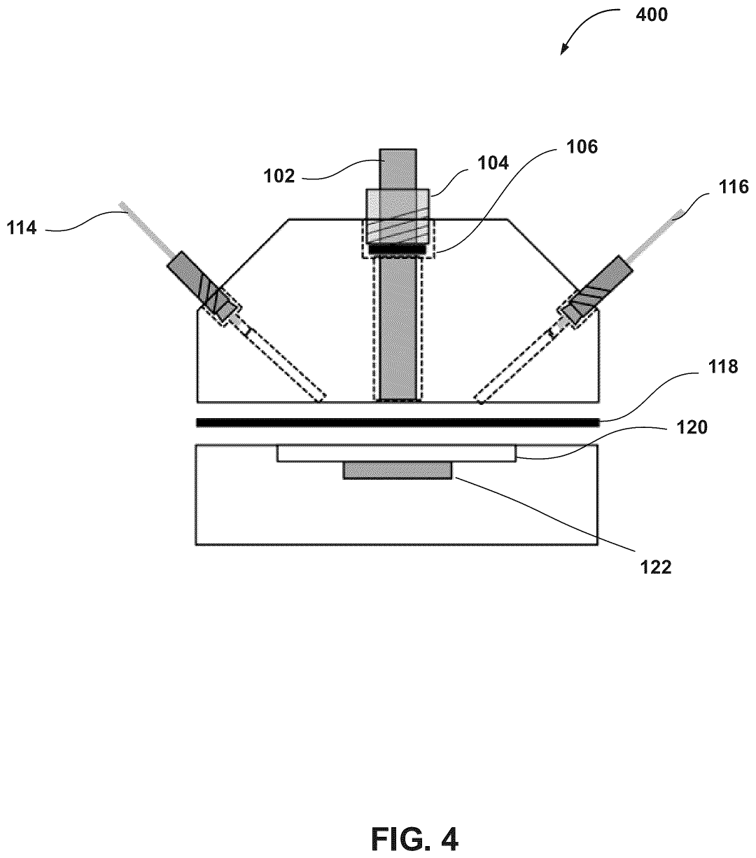

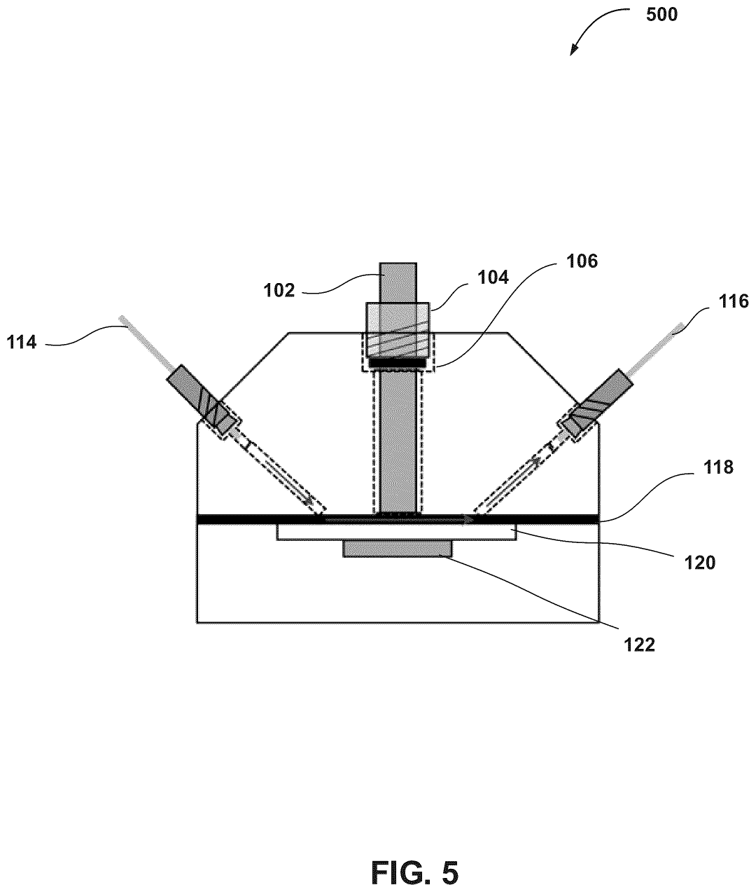

FIGS. 4 and 5 are diagrams 400 and 500 that illustrate a side view of the Raman Spectroscopy system and present a sheet flow design of the Raman Spectroscopy system, in accordance with another embodiment of the present invention. In this embodiment, as shown, the sheet flow Raman spectroscopy system comprises two compartments: an upper compartment and a bottom compartment. The upper compartment consists of the optical probe 102, the securing nut, the O-ring 106, the fluid inlet 114, and the fluid outlet 116. The bottom compartment consists of a window 120 and an anti-reflective, non-fluorescent material 122. There is further shown a gasket 118 between the upper compartment and the bottom compartment.

The upper compartment is comprised of various components. Firstly, there is the optical probe 102, which is responsible for capturing and directing the laser beam onto the sample being analyzed. The optical probe is designed to have a specific shape and size suitable for the sheet flow Raman spectroscopy measurements. The securing nut 104, which is not specifically labeled in the figure but mentioned in the description, is used to securely hold the optical probe in place within the system. It ensures that the probe remains in the correct position for accurate analysis. To prevent any leakage or contamination between the compartments, an O-ring 106 is utilized. The O-ring provides a seal that ensures a tight and secure connection between the upper and bottom compartments, preventing the escape of fluids or entry of external contaminants. The fluid inlet 114 and fluid outlet 116 are additional features in the upper compartment. The fluid inlet is used to introduce the fluid sample into the system for analysis, while the fluid outlet allows for the controlled removal of the fluid after analysis is complete. These components facilitate the flow of the fluid through the system, enabling efficient sample analysis.

Moving to the bottom compartment, it consists of a window 120 and an anti-reflective, non-fluorescent material 122. The window is typically made from a transparent material that is compatible with the Raman spectroscopy process. The crucial innovation in this invention lies in the anti-reflective, non-fluorescent material 122 incorporated into the bottom compartment, behind the window. This material is designed to minimize or eliminate unwanted reflections and fluorescence interference that can occur if light is allowed to interact with the flow cell body material. It ensures that the Raman signals are not distorted or obscured by any undesired optical effects. Between the upper compartment and the bottom compartment, a gasket 118 is present. The gasket acts as a fluid conduit, providing a secure separation between the two compartments while providing a route for the sample solution to flow through the measurement cell. Collectively, these components and compartments work together to create an effective Raman spectroscopy system. The upper compartment houses the optical probe, fluid inlet, fluid outlet, and sealing elements, while the bottom compartment contains the window and the innovative anti-reflective, non-fluorescent material. The gasket ensures proper compartmentalization, enabling precise and accurate sample analysis while minimizing unwanted optical effects.

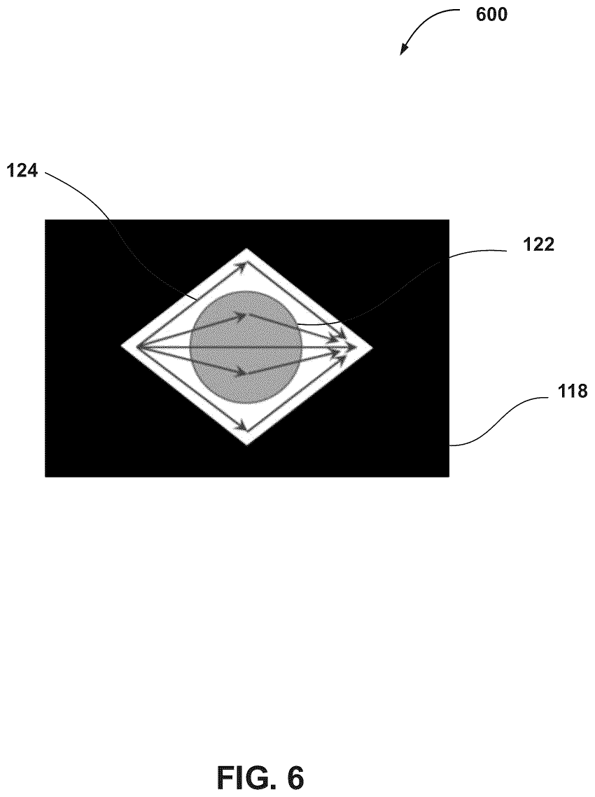

FIG. 6 is a diagram 600 that illustrates a top view of a bottom compartment of the sheet flow Raman Spectroscopy system, in accordance with another embodiment of the present invention. FIG. 6 presents a top view of the bottom compartment of the sheet flow Raman spectroscopy system, providing a visual representation of its key features and fluid flow patterns. The diagram showcases a diamond-shaped cutout 124, which is strategically designed to allow the smooth flow of fluid within the system. The cutout serves as a pathway for the fluid as it passes through the bottom compartment during the analysis process. The anti-reflective, non-fluorescent material 122 is depicted within the bottom compartment in FIG. 6. This material, as previously discussed, plays a critical role in minimizing unwanted reflections and fluorescence interference, thereby enhancing the accuracy and reliability of Raman spectroscopy measurements. The gasket 118 is also visible in the diagram, serving as a sealing element between the upper and bottom compartments. The gasket ensures a secure separation of the compartments while maintaining the integrity of the system and preventing any leakage or contamination.

Regarding the fluid flow operation depicted in FIG. 6, it begins with the fluid entering through an inlet hole, which is positioned above the left-hand corner of the gasket cutout. This inlet hole serves as the entry point for the fluid into the bottom compartment. Once inside the compartment, the fluid follows multiple alternative paths along the diamond-shaped cutout 124, as indicated by the red arrows in the diagram. The purpose of these alternative paths is to ensure efficient and uniform fluid flow, allowing the sample to be evenly exposed to the laser beam for accurate analysis. Finally, the fluid exits the bottom compartment through the drain hole, which is located above the right-hand corner of the gasket cutout. The drain hole serves as the outlet for the fluid, enabling its controlled removal from the system once the analysis is complete.

Overall, FIG. 6 illustrates the top view of the bottom compartment of the sheet flow Raman spectroscopy design system, highlighting the diamond-shaped cutout 124, the anti-reflective, non-fluorescent material 122, and the gasket 118. The diagram also showcases the fluid flow operation, demonstrating how the fluid enters through the inlet hole, flows along the cutout via alternative paths, and exits through the drain hole. This design ensures efficient fluid movement within the system, allowing for accurate and reliable Raman spectroscopy measurements.

The sheet flow design of the Raman spectroscopy system, as illustrated in FIGS. 4 to 6, presents a sophisticated and innovative approach to accurate sample analysis. This system is composed of two integral compartments, each housing crucial components that contribute to efficient fluid handling and optimal interaction with the optical probe. The upper compartment encompasses key features, including the optical probe 102 responsible for directing the laser beam onto the sample. The securing nut ensures the probe's secure positioning, while the O-ring 106 maintains a tight seal between compartments, preventing any fluid leakage or contamination. The fluid inlet 114 and fluid outlet 116 facilitate controlled sample introduction and removal, ensuring smooth fluid flow for accurate analysis. Moving to the bottom compartment, the window 120 serves as the optical interface for laser beam interaction with the sample. It allows the beam to penetrate and interact with the sample while maintaining the enclosed conditions. A notable innovation in this design is the incorporation of the anti-reflective, non-fluorescent material 122 incorporated into the bottom compartment, behind the window 120. This material is strategically integrated to counteract unwanted reflections and fluorescence interference during analysis, if light is allowed to interact with the flow cell body material, enhancing measurement accuracy. The gasket 118 acts as a fluid conduit between compartments, maintaining a secure separation between the two compartments while providing a route for the sample solution to flow through the measurement cell. FIG. 6 presents a top view of the bottom compartment, emphasizing the diamond-shaped cutout 124 designed to facilitate fluid flow. Fluid enters through the inlet hole above the gasket cutout's left corner, flows along multiple alternative paths within the cutout, and exits through the drain hole above the right corner. This design ensures uniform fluid exposure to the laser beam, vital for accurate analysis. The anti-reflective, non-fluorescent material 122 and the gasket 118 are also highlighted in the diagram. Collectively, these components and compartments collaboratively form an advanced sheet flow Raman spectroscopy design. The upper compartment houses optical and fluid management elements, while the bottom compartment features the innovative anti-reflective, non-fluorescent material and optical interface. The strategic fluid flow pattern within the bottom compartment ensures uniform interaction with the laser beam, while the system's well-engineered components enhance measurement accuracy and reliability. In summary, the sheet flow design, exemplified in FIGS. 4 to 6, presents a comprehensive solution for precise and efficient Raman spectrometry analysis within an enclosed environment.

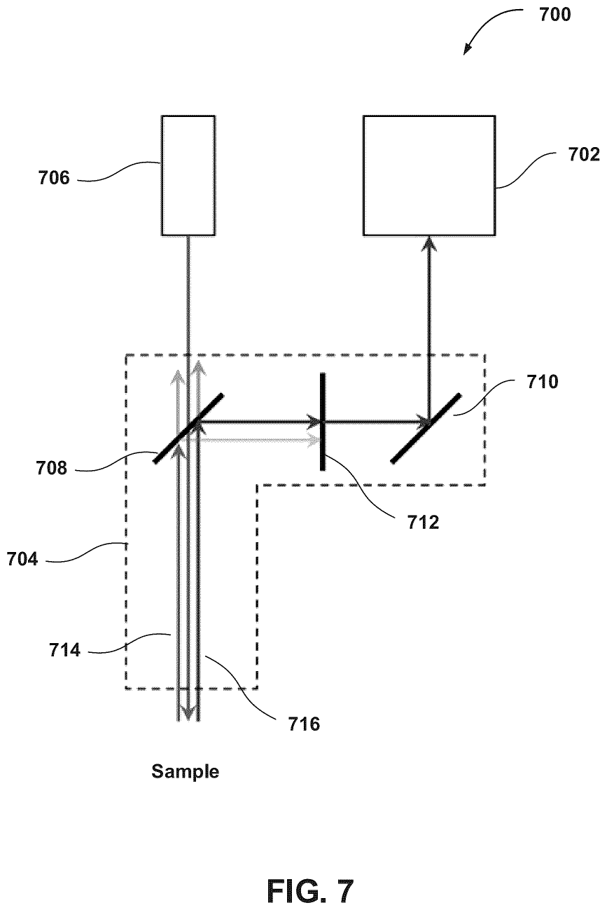

FIG. 7 is a diagram 700 that illustrates an arrangement for presenting Raman probe operation, in accordance with an embodiment of the present invention. The Raman probe 704 is an essential component of the Raman spectroscopy system, specifically designed to collect and analyze the scattered light from the sample. It consists of several components that enable the proper handling and manipulation of the light signals. One of the key components within the Raman probe is the beam splitter 708. The beam splitter allows the incoming light, which includes both the backscattered light and the Raman scattered light, to be split into two separate paths. One path directs the light towards the detector, while the other path is used for further processing. To remove the excitation light 714, which can be overwhelming in intensity and mask the weaker Raman scattered light, a notch filter 712 is incorporated into the probe. The notch filter 712 selectively blocks the excitation light 714 while allowing the Raman scattered light to pass through. This filtering process significantly enhances the sensitivity and accuracy of the Raman spectroscopy measurements by reducing the interference from the excitation light 714. The mirror 710 is positioned within the Raman probe to redirect the filtered Raman scattered light towards the detector. The mirror ensures that the collected Raman scattered light is efficiently reflected towards the detector, optimizing the signal strength, and improving the overall sensitivity of the measurement. Together, these components within the Raman probe work in tandem to isolate and analyze the Raman scattered light emitted from the sample. The beam splitter separates the light paths, the notch filter removes the excitation light 714, and the mirror redirects the Raman scattered light towards the detector, enabling precise and accurate analysis of the sample's molecular composition and properties.

In the Raman spectroscopy system, the laser 706 serves as the excitation light source. It provides a focused beam of light that is directed onto the sample being analyzed. The optical probe 704, a crucial component of the system, guides and focuses the excitation light onto the sample, ensuring efficient interaction between the light and the molecules within the sample. When the excitation light illuminates the sample, several phenomena occur. First, there is backscatter, also known as elastic scattering, where some of the incident light is scattered back in exactly the same wavelength as the excitation light. This backscattered light 714 provides information about the overall structure and composition of the sample. In addition to backscatter, there is also inelastic scattering, specifically Raman scattering. In this process, the sample scatters light at wavelengths that are either lower or higher in wavelength compared to the excitation light. This wavelength shift provides valuable information about the chemical properties and molecular structure of the sample. The intensity of Raman scattered light is much lower compared to the backscattered light 714 but carries crucial molecular information. Furthermore, the sample can emit light at lower wavelengths compared to the excitation light range. This phenomenon is called photoluminescence. It occurs within the same wavelength range as Raman scattering, but the molecular process responsible for its generation is different. Unlike Raman scattering, photoluminescence typically provides limited information about the chemical properties of the sample. Although lower in intensity compared to the backscattered light 714, photoluminescence is still significantly stronger than Raman scattering. The optical probe 704 is responsible for collecting all the light originating from the sample, including backscattered light, Raman scattered light, and photoluminescence. To ensure accurate analysis, the probe 704 incorporates a notch filter, which effectively removes most of the excitation light from the collected signal. This filtering process allows the Raman scattered light and a reduced amount of photoluminescence to be transmitted to the Raman spectrometer 702 for further analysis. However, since photoluminescence falls within the same wavelength range as Raman scattering, it cannot be completely eliminated through optical means. Therefore, it is essential to carefully configure the measurement conditions in order to minimize the generation of photoluminescence. By controlling various factors such as laser power, sample preparation, and environmental conditions, the undesired contribution of photoluminescence to the measured signal can be minimized, allowing for more accurate Raman spectroscopy analysis focused on the sample's chemical properties.

Raman radiation 716 refers to the specific type of scattered light that is generated within the sample as it is illuminated by the excitation light in a Raman spectroscopy system. When the sample is exposed to the intense laser light, the interaction between the incident light and the molecules in the sample leads to various scattering phenomena, including Raman scattering. The Raman radiation 716 specifically refers to the light that is emitted from the sample because of this Raman scattering process. This radiation contains characteristic spectral features that correspond to the vibrational or rotational modes of the molecules in the sample. By analyzing the wavelengths and intensities of the Raman radiation, valuable insights into the molecular properties, chemical bonds, and structural characteristics of the sample can be obtained. In a Raman spectroscopy system, the Raman radiation 716 is collected and analyzed by the optical components, such as the Raman probe, beam splitter, filters, and detectors, to generate a Raman spectrum. This spectrum provides a unique fingerprint of the sample, allowing for identification and quantitative analysis of its chemical composition and molecular properties.

The disclosed Raman spectroscopy system (fountain type or sheet flow design) offers a comprehensive solution for precise and reliable analysis of fluid samples. The system comprises a flow cell with an optical probe specifically designed for Raman spectrometry measurements. The flow cell incorporates a fluid inlet and outlet, allowing controlled routing of the fluid sample into and out of the cell. Crucially, the system incorporates an anti-reflective, non-fluorescent material positioned opposite the optical interface of the flow cell. By orienting the fluid inlet to face the optical probe, the system effectively prevents interfering reflections and fluorescence from the flow cell material. This feature ensures accurate and untainted measurements, free from optical distortions or background noise. The anti-reflective, non-fluorescent material further reduces unwanted reflections and minimizes fluorescence interference, optimizing the clarity and sensitivity of the Raman spectroscopy measurements. The versatility of the system is highlighted by its integration options. The flow cell can be seamlessly incorporated into a process reactor, process stream, or fluidic instrument, facilitating analysis under enclosed conditions. It can also be positioned in a split stream configuration, ensuring measurements without compromising the integrity of the overall process. This enables real-time analysis of fluid samples without exposing them to ambient conditions, minimizing the risk of contamination or alteration. The optical probe within the flow cell plays a pivotal role in the system's performance. It guides excitation light onto the sample, leading to various scattering phenomena. The probe collects backscattered light at the same wavelength as the excitation light (elastic scattering), as well as inelastically scattered light at lower or higher wavelengths (Raman effect). Additionally, it captures emitted light at lower wavelengths (photoluminescence). To enhance the quality of the collected signal, the probe incorporates a notch filter to remove most of the excitation light. Importantly, the system's innovative design minimizes the generation of photoluminescence, which often overlaps with Raman scattering in wavelength range. This ensures that the collected data predominantly reflects the chemical properties of the sample, enhancing the accuracy and reliability of the analysis. Additional features of the system include the use of a flat-bottom probe as the optical interface, which improves stability and case of use during measurements. A gasket positioned between the upper and bottom compartments provides a secure separation, preventing leakage or contamination. The system also incorporates a diamond-shaped cutout in the bottom compartment, allowing fluid to flow along multiple alternative paths before exiting through the fluid outlet. In summary, the disclosed Raman spectroscopy system offers a comprehensive solution for analyzing fluid samples. Its incorporation of an anti-reflective, non-fluorescent material, along with precise control of fluid flow and integration options, ensures accurate and reliable measurements. The system's innovative features, including the flat-bottom probe, notch filter, and optimized generation of photoluminescence, further enhance the quality and specificity of the obtained data.

Raman spectroscopy systems can employ different fluid handling designs to interact with the sample being analyzed. Two common designs are the “fountain type” design and the “sheet flow” design, each offering unique advantages in terms of fluid handling and analysis.

In one embodiment, in the fountain type design, the fluid enters the measurement chamber from a single inlet, typically positioned above the optical probe or target area. As the fluid flows into the chamber, it impacts a surface or structure, often referred to as the “splash plate” or “impact surface.” This impact creates a dispersing effect, resembling a fountain, where the fluid is sprayed or distributed in various directions. Advantages include (1) efficient mixing: The fountain type design promotes thorough mixing of the sample, ensuring that the excitation light and the emitted Raman scattered light interact with a representative portion of the sample. (2) homogeneous analysis: The dispersing effect helps ensure a uniform distribution of the sample across the optical interface, minimizing any potential concentration gradients.

In another embodiment, the sheet flow design involves the controlled flow of the sample in a thin, flat layer across the optical interface. This design often employs a wider inlet or distribution system that spreads the fluid across the optical probe's surface. The fluid then flows in a relatively thin, sheet-like layer. Advantages include (1) reduced optical pathlength variability: With the sample spread out in a thin layer, the optical pathlength (distance the light travels through the sample) can be more consistent, which can improve the accuracy of quantitative measurements. (2) minimized signal variations: The sheet flow design can help reduce variations in Raman signal intensity, particularly when analyzing samples with varying concentrations.

Both the fountain type and sheet flow designs have their specific applications and advantages, and the choice between them often depends on the nature of the sample, the desired analysis accuracy, and the specific goals of the Raman spectroscopy experiment. The selection of the appropriate design contributes to optimizing the fluid dynamics within the measurement chamber and enhancing the overall quality of Raman spectroscopy measurements.

The disclosed invention, which incorporates an anti-reflective, non-fluorescent material into a Raman spectroscopy system, offers several advantages that significantly improve the ability to analyze samples. Firstly, the inclusion of the anti-reflective material eliminates or minimizes unwanted reflections, enhancing the accuracy and reliability of the measurements. This ensures that the Raman signals from the sample are not distorted or compromised by interfering optical effects. Additionally, the use of a non-fluorescent material mitigates fluorescence interference, allowing for clearer and more precise analysis of the Raman scattered light. Another advantage of this invention lies in the design of the flow cell, which includes a fluid inlet and outlet. By incorporating the flow cell into a process reactor, process stream, or fluidic instrument, the invention enables measurements to be made on fluid samples within enclosed conditions. This eliminates the need to expose the fluid to ambient conditions, thereby preserving the integrity of the process and avoiding any potential contamination or alteration of the sample during analysis. The flow cell can be integrated into a split stream off of a process stream or reactor, allowing for measurements by Raman spectrometry without compromising the overall process. Furthermore, the invention permits the use of a flat-bottom probe as the optical interface. This is advantageous because flat-bottom probes are commonly used in Raman spectrometry and offer improved stability and case of use. By allowing the optical probe to face the inlet channel, the invention ensures that no interfering reflections or fluorescence from the flow cell material can occur. This configuration maximizes the accuracy and sensitivity of the Raman measurements, enhancing the detection and analysis of the sample's chemical properties. Overall, the disclosed invention provides multiple advantages for Raman spectroscopy analysis. The incorporation of the anti-reflective, non-fluorescent material eliminates unwanted optical effects, enhancing the reliability and accuracy of the measurements. The enclosed flow cell design preserves the integrity of the sample during analysis, avoiding contamination or alteration. Additionally, the use of a flat-bottom probe as the optical interface optimizes the detection and minimizes interference, enabling more precise and sensitive analysis of the sample's chemical properties.

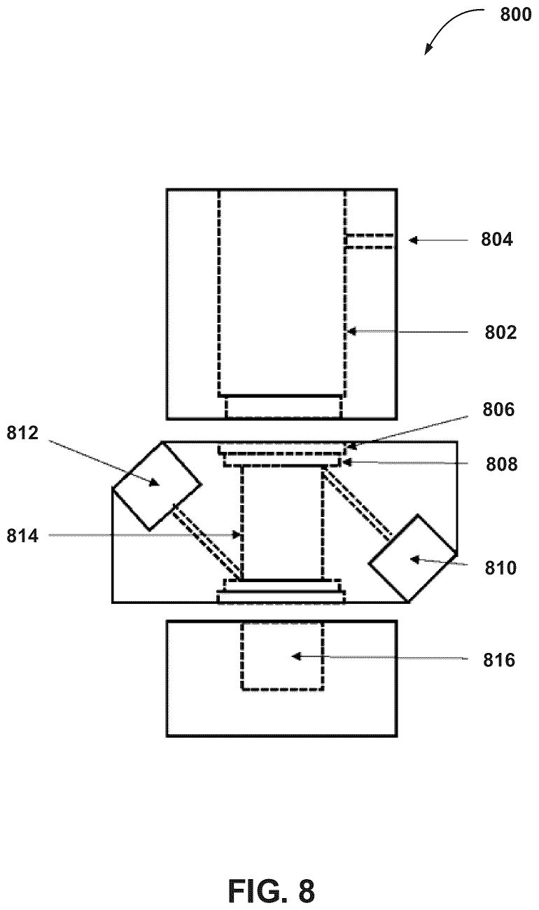

FIG. 8 is a diagram 800 that illustrates a Z-style Raman spectroscopy flow cell, in accordance with an embodiment of the present invention. The diagram 800 illustrates a cross-sectional view of the Z-style Raman spectroscopy flow cell. This flow cell is designed to facilitate in situ Raman measurements of a fluid sample under enclosed conditions. The flow path and optical path form a “Z” configuration, enabling the laser beam to interact with the fluid while minimizing back-reflection and fluorescence interference. Various key components include a Raman probe 802, set screw 804, O-ring 806, window 808, fluid inlet port 810, fluid exit port 812, optical channel 814, and beam dump cavity 816.

The Raman probe 802 collects and directs laser excitation light into the sample and receives the Raman-scattered light for analysis. The probe is mounted vertically above the window and is optically aligned with the fluid channel beneath it.

The set screw 804 mechanically secures the Raman probe 802 in place within the housing or holder block. The set screw 804 provides adjustable mechanical retention without affecting optical alignment.

The O-Ring 806 provides a leak-proof seal between the Raman probe 802 and the window or flow cell body 808. The O-Ring 806 prevents sample fluid from escaping and maintains a controlled optical environment.

The window 808 is a transparent interface between the Raman probe 802 and the fluid sample. The window 808 isolates the probe from direct contact with the sample, preventing contamination while preserving optical access.

The fluid inlet port 810 is the entry point for the fluid sample into the flow cell. The fluid inlet port 810 is positioned at an angle, aligning with the optical channel to direct fluid flow toward the center region under the Raman probe 802.

The fluid exit port 812 is an outlet for the fluid sample after it has passed through the measurement zone. The fluid exit port 812 is also positioned at an angle to maintain a smooth flow path and avoid turbulence.

The optical channel 814 is a space or volume where the laser beam passes through the fluid for Raman interaction. The geometry ensures the beam travels some distance in the fluid before encountering any hard surface, reducing noise from reflections and increasing sensitivity.

The beam dump cavity 816 is a cavity located at the bottom of the optical path to safely absorb and dissipate unused or transmitted laser energy. It is lined with non-reflective, non-fluorescent material to eliminate stray reflections and background signal that could interfere with Raman signal collection.

The Z-style flow cell has been designed to guide the fluid sample diagonally through a channel beneath a window, where it is exposed to laser illumination from the Raman probe 802. As the fluid enters through the fluid inlet port 810, it travels across the optical channel 814, directly beneath the window 808, allowing the Raman probe 802 to excite and collect scattered light from the sample. The fluid then exits through the fluid exit port 812. Any transmitted or unabsorbed laser beam continues downward into the beam dump cavity 816, which neutralizes stray light and prevents interference in detection. This configuration preserves the advantages of a long beam path and minimized optical noise while improving upon earlier designs (e.g., fountain design) by: physically separating the probe from the sample using a window, allowing integration of a beam dump cavity, reducing contamination risk, and improving signal-to-noise performance by minimizing internal reflections.

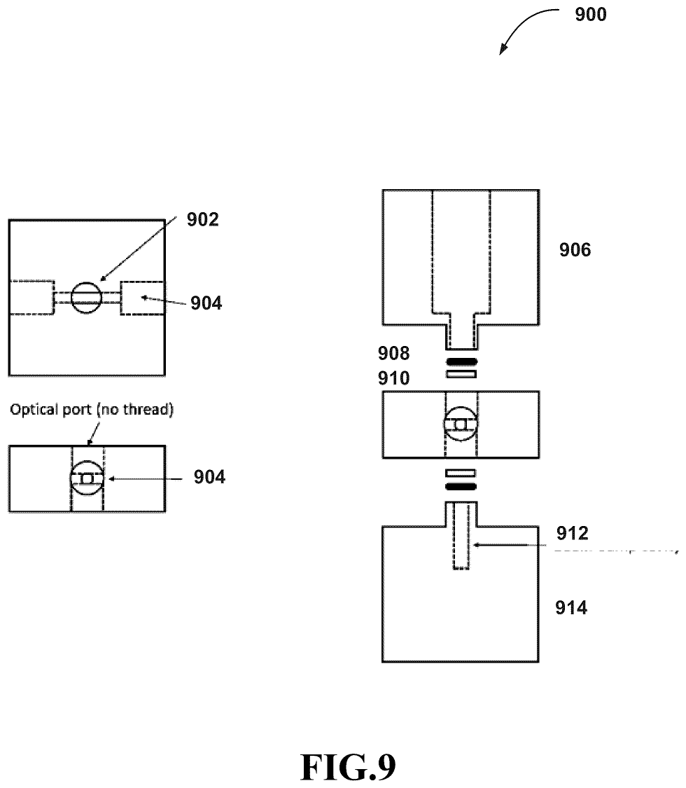

FIG. 9 is a diagram 900 that illustrates a T-style Raman spectroscopy flow cell, in accordance with an embodiment of the present invention. The diagram 900 illustrates a modular assembly view of the T-style Raman spectroscopy flow cell. The design is characterized by a T-shaped configuration with horizontal fluid flow through a central chamber and vertical optical access. This configuration allows Raman measurements of fluid samples while overcoming limitations of prior designs (such as the sheet flow design). Key components include an optical port 902, fluidic ports 904, end cap for probe 906, O-rings 908, window 910, beam dump cavity 912, and a blind end cap 914.

The optical port (No Thread) 902 provides vertical optical access from the Raman probe to the sample inside the flow cell. The optical port 902 is unthreaded to allow easy alignment of the optical axis and seamless interfacing with a window or transparent insert. The probe does not come in direct contact with the fluid sample.

The fluidic port (Threaded) 904 provides entry and exit points for fluid flow through the horizontal flow channel. The threaded connections allow for secure and leak-proof integration with external tubing or fluid handling systems. The ports may be used symmetrically or asymmetrically depending on flow requirements.

The end cap for probe 906 secures the Raman probe above the optical port 902. The cap 906 allows precise probe positioning while preventing contamination and mechanical wear. It interfaces with the top of the flow cell through an O-ring-sealed connection.

The O-Ring 908 provides a leak-proof seal at key joints, especially where the probe window 910 and the beam dump cavity 912 interface with the central chamber. The standard O-rings 908 are used instead of customized gaskets, simplifying manufacturing and improving pressure handling.

The window 910 is a transparent optical barrier between the Raman probe and the sample fluid. The window 910 ensures optical clarity while physically isolating the probe from the fluid. It enhances measurement consistency and hygiene, especially in sterile or corrosive environments.

The beam dump cavity 912 is a dedicated channel below the optical path that safely absorbs the laser beam after it passes through the sample. The cavity 912 is aligned with the optical axis and is designed to minimize stray reflections by being lined (optionally) with non-reflective, non-fluorescent materials.

The blind end cap 914 seals the beam dump cavity from below and provides physical termination for the laser path and optionally includes light-absorbing or heat-dissipating material. It is removable for maintenance or cleaning.

In operation, the fluid enters the central horizontal flow chamber through one fluidic port and exits through the opposite port. The Raman probe, mounted vertically via the end cap, directs excitation light through the window and into the flowing sample. The scattered Raman light is collected back through the same optical port. Any transmitted laser beam continues downward into the beam dump cavity, where it is absorbed to prevent stray light from reflecting back into the detection optics. The window isolates the fluid from the probe, eliminating direct contact and preserving probe integrity. The use of standard O-rings instead of custom gaskets improves manufacturability, pressure tolerance, and ease of maintenance.

The present invention discloses two novel Raman flow cell configurations: one is the Z-design and another one is the T-design, each addressing critical limitations while enhancing performance, manufacturability, and adaptability for in situ fluid analysis. The Z-design is an improvement over the fountain-type configuration, featuring an angled optical path where the Raman excitation beam passes through a fluid-filled optical channel before encountering a hard surface, allowing the beam to expand beyond its focal point and thereby reducing background noise from scattering or reflection. This design uniquely incorporates a beam dump cavity aligned with the optical axis and lined with non-reflective, non-fluorescent material to absorb excess laser energy, significantly improving signal-to-noise ratio. Additionally, the Z-design physically isolates the Raman probe from the fluid sample using a transparent window, eliminating direct contact and minimizing contamination risk while maintaining high measurement accuracy. In contrast, the T-design enhances upon the sheet flow architecture with a compact, modular assembly featuring horizontal fluid flow and vertical optical access, enabling minimal dead volume and highly reproducible measurements. The T-design further improves practicality by separating the probe using a window, enabling the use of standard O-rings instead of custom gaskets, which simplifies manufacturing, enhances pressure resistance, and improves sealing reliability. Moreover, the fluid ports are positioned outside the probe holder, allowing easy customization for different probe sizes without redesigning the entire housing. Both designs prioritize cleanability, optical integrity, manufacturing efficiency, and flexible integration into industrial fluidic systems, making them highly advantageous for high-precision, real-time Raman spectroscopy applications.

The present invention further encompasses an integrated Raman spectroscopy system that combines a Raman spectrometer with the novel flow cell designs described herein, namely, the Z-design and T-design flow cells. The integrated system enables in situ or inline chemical analysis of fluid samples under enclosed, sterile, or industrial process conditions, with high signal clarity, minimized background interference, and improved usability.

In one embodiment, the system includes a Raman spectrometer unit, comprising a laser excitation source, optical filters, a beam-splitting mechanism, and a detector (e.g., CCD). The system may further include Raman probe, optically coupled to the spectrometer via a fiber-optic cable and configured to deliver laser excitation to the sample and collect Raman-scattered light for spectral analysis. The system may further include Z-design flow cell or T-design flow cell, integrated in-line with a fluid handling system or process stream, and positioned for real-time monitoring of fluid samples. The Raman probe is mounted in an optical port of the flow cell and secured using a mechanical retention mechanism such as a set screw or threaded coupling. In the Z-design, the probe is optically aligned with an angled optical channel within the flow cell and optically separated from the sample via a transparent window. The beam propagates through the sample volume and is directed toward a beam dump cavity that absorbs residual excitation light using non-reflective, non-fluorescent materials. This configuration enhances spectral signal-to-noise by minimizing back-reflection and photoluminescent interference.

In the T-design flow cell embodiment, the Raman probe is mounted vertically over a window positioned above a horizontal fluidic flow channel. The fluid flows through inlet and outlet ports located on opposing sides of the channel, and the probe directs laser excitation through the window without making direct contact with the fluid. A beam dump cavity aligned with the optical axis is positioned below the flow channel to absorb unscattered light. The T-design allows modular assembly, with standard O-rings used for sealing interfaces, simplifying manufacturing, improving pressure resistance, and enabling easy customization for probes of varying size or optical path length.

The integrated system may further include a control unit and software interface configured to operate the Raman spectrometer and probe, display real-time Raman spectra, apply chemometric algorithms or spectral libraries for molecular identification or concentration analysis, and log data for quality control or regulatory compliance. The system can be mounted on a skid, panel, or installed inline with chemical reactors, pharmaceutical production lines, water treatment systems, or any application requiring precise, real-time monitoring of chemical composition in a liquid medium. The integration of the Raman spectrometer with either the Z-design or T-design flow cells provides significant improvements over conventional systems, including: enhanced optical performance due to reduced stray light and fluorescence interference, reliable probe isolation from the sample for reduced maintenance, scalable and customizable hardware for varied industrial applications, In situ measurement capabilities without disrupting the fluidic process. These integrated systems make Raman spectroscopy more robust, adaptable, and accurate for use in demanding analytical environments, enabling expanded deployment in continuous processing, diagnostics, and field applications.

Although the present invention has been described with respect to various schematic representations (FIGS. 1-9), it should be understood that the proposed Raman Spectroscopy System and method can be realized and implemented with varying shapes and sizes, and thus the present invention here should not be considered limited to the exemplary embodiments and processes described herein. The various dimensions may be modified to fit in specific application areas. Although particular embodiments of the invention have been described in detail for purposes of illustration, various modifications and enhancements may be made without departing from the spirit and scope of the invention.

What is claimed is:

1. A Raman spectroscopy system comprising:
a flow cell comprising an optical channel for receiving a laser beam from a Raman probe;
a fluid inlet and a fluid outlet for routing a fluid sample through the optical channel;
a window positioned between the Raman probe and the optical channel to allow optical access while isolating the probe from the fluid; and
a beam dump cavity aligned with the optical channel and positioned to receive unscattered portions of the laser beam,
wherein, the beam dump cavity includes a non-reflective and non-fluorescent interior surface to absorb stray light and reduce optical interference during Raman spectrometry measurements.

2. The Raman spectroscopy system of claim 1, wherein the optical channel is angled such that the laser beam passes through the fluid at an oblique path relative to the flow direction.

3. The Raman spectroscopy system of claim 1, wherein the window is optically transparent and forms a sealed interface with the flow cell via an O-ring.

4. The Raman spectroscopy system of claim 1, wherein the beam dump cavity is detachable and housed in a removable end cap.

5. The Raman spectroscopy system of claim 1, wherein the Raman probe is secured in place using a threaded or set screw connection.

6. A Raman spectroscopy system comprising:
a horizontal flow channel with a fluid inlet port and a fluid outlet port configured to route a fluid sample through the channel;
an optical port disposed perpendicular to the flow channel and configured to receive light from a Raman probe;
a window disposed between the optical port and the flow channel to allow optical access to the fluid without direct contact between the probe and the fluid; and
a beam dump cavity aligned with the optical axis of the optical port and configured to absorb unscattered light,
wherein the flow cell includes at least one O-ring for sealing the window or the optical port.

7. The Raman spectroscopy system of claim 6, wherein the fluid inlet and outlet ports are threaded and located outside the probe holder block to allow easy customization.

8. The Raman spectroscopy system of claim 6, wherein the beam dump cavity is formed in a blind end cap positioned below the optical port.

9. The Raman spectroscopy system of claim 6, wherein the O-ring is a standard off-the-shelf sealing component.

10. The Raman spectroscopy system of claim 6, wherein the window is removable for cleaning or replacement.
